(19) United States
(12) Patent Application Publication
(10) Pub. No.: US 2020/0042869 A1
(43) Pub. Date: Feb. 6, 2020

(54) Self-Trained Analog Artificial Neural Network Circuits

(71) Applicant: University of Massachusetts, Boston, MA (US)

(72) Inventors: David P. Rancour, Fall River, MA (US); Howard E. Michel, Dartmouth, MA (US)

(21) Appl. No.: 16/456,954

(22) Filed: Jun. 28, 2019

Related U.S. Application Data
(60) Provisional application No. 62/714,429, filed on Aug. 3, 2018.

(51) Int. Cl. G06N 3/063; G06N 3/08

(52) U.S. Cl. CPC G06N 3/0635; G06N 3/088

(57) ABSTRACT

An integrated circuit can include artificial neural network circuitry, and training circuitry configured to train the artificial neural network.

### CROSS-REFERENCE TO RELATED APPLICATIONS

This application claims the benefit under 35 U.S.C. § 119(e) of the filing date of U.S. Patent Application No. 62/714,429, for SELF-TRAINED ANALOG ARTIFICIAL NEURAL NETWORK CIRCUITS, which was filed on Aug. 3, 2018, and which is incorporated here by reference.

### BACKGROUND

A neural chip is an analog or digital integrated circuit that implements several processing elements, which are often referred to as “neurons.” These neurons are independent and can be operated in parallel. Such neural chips are often used as building blocks for assembling larger networks.

### SUMMARY

In general, one innovative aspect of the subject matter described in this disclosure is embodied in an integrated circuit including artificial neural network circuitry, and training circuitry configured to train the artificial neural network circuitry.

Particular implementations of the above may include one or more of the following features. The artificial neural network circuitry may employ a plurality of artificial neurons, wherein at least one artificial neuron of the plurality of artificial neurons adjusts an input signal using a weight. The training circuitry may be configured to train the artificial neural network by adjusting the weight of the at least one artificial neuron.

The training circuitry may be configured to train each of the plurality of artificial neurons in parallel. The training circuitry may include a track and hold circuit that provides a value based on a weight to the artificial neural network circuitry, wherein the weight is generated based on an output-layer of the artificial neural network circuitry. The value may be based on a signal from a hidden layer of the artificial neural network.

In general, another innovative aspect of the subject matter described in this disclosure is embodied in a system and methods for training an artificial neural network. One of the methods includes providing input signals and at least one output signal to an integrated circuit, wherein the integrated circuit includes artificial neural network circuitry and training circuitry configured to train the artificial neural network. The method also includes training the artificial neural network using the training circuitry, the training including adjusting weights in parallel based on the output signal, wherein the weights are applied to the input signals by artificial neurons employed in the artificial neural network circuitry.

The foregoing and other implementations can each optionally include one or more of the following features, alone or in combination. Each of the plurality of artificial neurons can be configured to be trained in parallel. The training circuitry can be configured to train each of the plurality of artificial neurons in parallel. The training circuitry can include a track and hold circuit that provides a value based on a weight to the artificial neural network circuitry, the weight generated based on an output-layer of the artificial neural network circuitry. The value may be based on a signal from a hidden layer of the artificial neural network. The training circuitry can include a track and hold circuit that provides a value based on a weight to the artificial neural network circuitry, the weight generated based on an output-layer of the artificial neural network circuitry. The value may be based on a signal from a hidden layer of the artificial neural network.

In another general aspect, a system for using a trained artificial neural network performs operations that comprise providing input signals to an integrated circuit, wherein the integrated circuit includes trained artificial neural network circuitry, training circuitry configured to train the artificial neural network circuitry, and output circuitry configured to provide an output from the artificial neural network circuitry. The trained artificial neural network circuitry is trained by the training circuitry. The operations also comprise receiving an output from the output circuitry.

Particular implementations of the above system may include one or more of the following features. The artificial neural network circuitry may employ a plurality of artificial neurons, at least one artificial neuron adjusting an input signal using a weight. The training circuitry may be configured to train the artificial neural network by adjusting the weight of the at least one artificial neuron. The training circuitry may include a track and hold circuit that provides a value based on a weight to the artificial neural network circuitry, wherein the weight may be generated based on an output-layer of the artificial neural network circuitry. The value may be further based on a signal from a hidden layer of the artificial neural network. Each artificial neuron in the artificial neural network may be configured to be trained in parallel.

The systems described herein each includes one or more processors. Each system also includes storage media storing instructions that, when executed by the one or more processors of the corresponding system, are configured to cause the one or more processors to perform the above-described operations.

Implementations of the above techniques include other methods, apparatus, systems and computer program products. One such computer program product is suitably embodied in a non-transitory machine-readable medium that stores instructions executable by one or more processors. The instructions are configured to cause the one or more processors to perform the above-described operations.

Unless otherwise defined, all technical and scientific terms used herein have the same meaning as commonly understood by one of ordinary skill in the art to which this invention belongs. Although methods and materials similar or equivalent to those described herein can be used in the practice or testing of the present invention, suitable methods and materials are described below. All publications, patent applications, patents, and other references mentioned herein are incorporated by reference in their entirety. In case of conflict, the present specification, including definitions, will control. In addition, the materials, methods, and examples are illustrative only and not intended to be limiting.

Other features and advantages of the invention will be apparent from the following detailed description, and from the claims.

### BRIEF DESCRIPTION OF THE DRAWINGS

FIG. 1 is a diagram of a three-layer perceptron.

FIG. 2 is a diagram of a dc voltage source array used to represent the numeral “2.”

FIG. 3 is a functional block diagram for an ANALOG DEVICES AD633AN four-quadrant analog multiplier chip.

FIG. 4 is a diagram of an activation function circuit and its voltage transfer characteristic curve.

FIG. 5 is a diagram of an output-layer neuron aggregation circuit.

FIG. 6 is a diagram of a training circuit for a single output-layer neuron.

FIG. 7 is a graph of output voltage transients for ten aggregation function circuits configured to recognize digit “8” and ignore digits “0”-“7” and “9.”

FIG. 8 is a graph illustrating a failure of output voltage transients to converge.

FIG. 9 shows a block diagram of a complex-valued artificial neuron.

Like reference numbers and designations in the various drawings indicate like elements.

### DETAILED DESCRIPTION

Artificial Neural Networks (ANN) are modeled after biological systems, mimicking the neurons and synapses of the brain. However, ANNs typically do not mimic the complex feedback mechanisms prevalent in physiology. As described herein by using a constantly adjusting feedback process, ANNs can be trained in a manner somewhat closer to the actual situation for living systems. As an example, described below is a Self-trained Multi-layer Analog Real-Time (“SMART”) ANN circuit architecture that solves a pattern recognition problem for numbers 0-9 in about 20 μs, using an assemblage of electronic components. The disclosed architecture enables real-time processing for both ANN function and training; If fabricated as an application-specific integrated circuit (ASIC) or a field-programmable gate array (FPGA), the SMART ANN circuit can perform both training and processing tasks in nanoseconds.

In common ANN models, the signal at a connection between artificial neurons is a real number, and the output of each artificial neuron is computed by some non-linear function of the sum of its inputs. Artificial neurons and inputs may have a weight that adjusts as learning proceeds (for example, each input to an artificial neuron may be separately weighted). The weight increases or decreases the strength of the signal at a connection. Artificial neurons may have a threshold such that the signal is only sent if the aggregate signal crosses that threshold. In general, the transfer functions between artificial neurons usually have a sigmoid shape, but they may also take the form of other non-linear functions, piecewise linear functions, or step functions. Typically, artificial neurons are aggregated into layers. Different layers may perform different kinds of transformations on their inputs. Signals travel from the first layer (the input layer), to the last layer (the output layer), possibly after traversing the layers multiple times.

Generally, the time required to train ANNs can range from seconds to days, depending on the scale of the neural network and the training method. Moreover, ANNs are typically realized as software emulations run on computers that execute their instructions serially, thereby losing the advantages of ANNs' inherent parallelism. In contrast, the disclosed analog circuit implementation of ANNs provide both fast real time training as well as real-time data processing. Feedback loops enable continuous adjustments of the ANN synapse weights while in training mode. Training for all weights occurs in parallel, at the response speed of the analog electronics regardless of the number of neurons. Using this circuit architecture, the ANN systems described herein solve the pattern recognition problem for numbers 0-9 in about 20 μs.

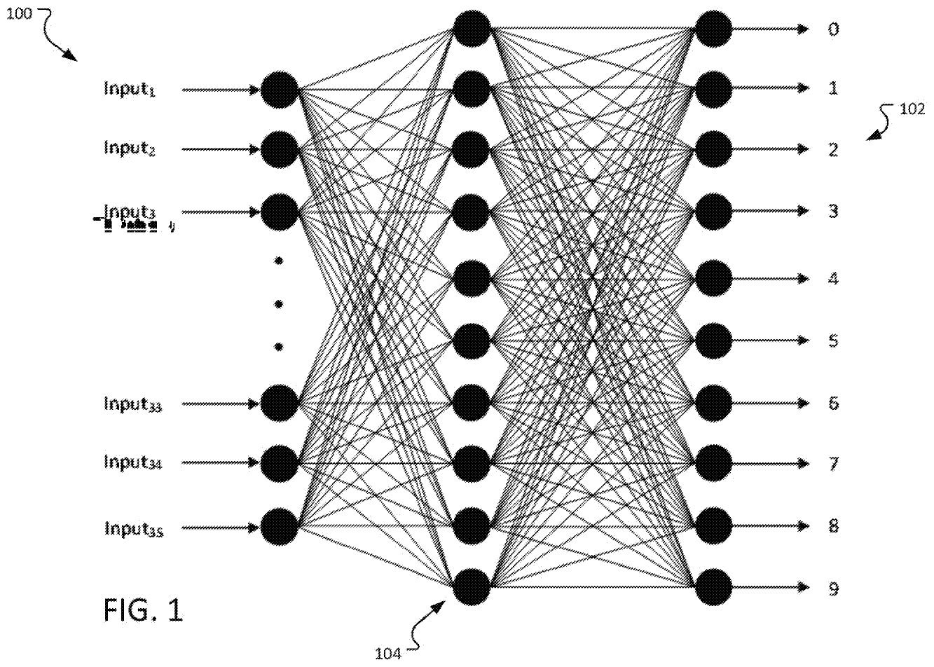

FIG. 1 illustrates a diagram of a three-layer perceptron 100, which is an analog circuit ANN that can solve the pattern recognition problem for numbers 0-9. In this context, a perceptron is an artificial neuron with an output value 0 or 1 based on whether the weighted sum of its inputs (e.g., inputs input₁, input₂, input₃, . . . , input₃₃, input₃₄ and input₃₅ of perceptron 100) is respectively less than or greater than a known threshold value. Each of the numbers 0-9 is defined by a 7×5 grid of black and white pixels, therefore the first layer of the perceptron 100 has 35 inputs. The output-layer 102 of the perceptron 100 has 10 neurons to identify the 10 digits 0-9. The perceptron 100 has an interior or hidden layer 104, with the number of neurons in the hidden layer 104 also being ten.

The architecture of the perceptron 100 as shown in FIG. 1 constitutes a Single hidden-Layer Feed Forward Neural Network (SLFF-NN), i.e., ANNs with one hidden layer that can be realized as an Extreme Learning Machine (ELM). Generally, a feed forward neural network is an ANN in which connections between the nodes of the network do not form a cycle with the ANN. In general, an ELM is a feedforward neural network for classification, regression, clustering, sparse approximation, compression and feature learning with a single layer or multiple layers of hidden nodes (e.g., nodes in interior layers, such as layer 104), where the parameters of hidden nodes (not just the weights connecting inputs to hidden nodes) do not need to be tuned. These hidden nodes can be randomly assigned and never updated (i.e. they are random projection but with nonlinear transforms), or can be inherited from their ancestors without being changed. The ELM algorithm is a non-iterative fixed-time training method for SLFF-NNs. ELM can achieve near real-time learning speed and is applicable to SLFF-NNs.

As an example, for the perceptron 100 with 35 inputs (e.g., inputs input₁, input₂, input₃, . . . , input₃₃, input₃₄ and input₃₅) and 10 outputs, the ELM method allows random selection of the 35×10=350 hidden-layer synapse values, leaving just 10×10=100 output-layer synapse values to be determined. In the perceptron 100, the 350 fixed hidden-layer synapse values are uniformly distributed between ±10 V, and SMART training circuits find the remaining 100 output-layer synapse weight values in real time.

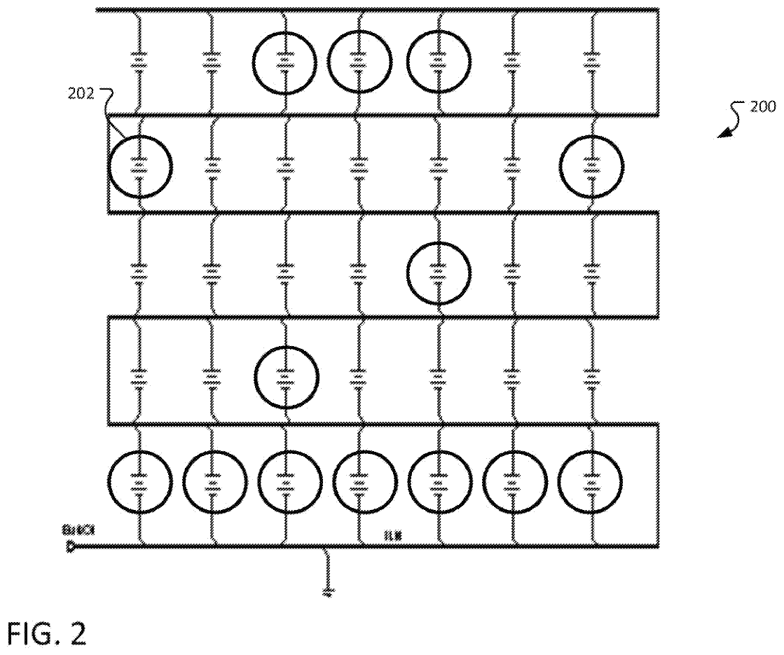

In one example, each of the 10 input pixel patterns is generated using arrays of 5×7=35 dc voltage sources. FIG. 2 is a diagram of a dc voltage source array 200 used to represent the numeral “2”. Each dc voltage source represents a pixel, and is set to a value of either +0.5 V or −0.5 V. The +0.5 V pixels are circled (for example, circle 202) in Error! Reference source not found., and it can be seen that they are positioned to roughly map out a pixel representation of the numeral “2”. Numerals 0-9 can be realized in a similar manner.

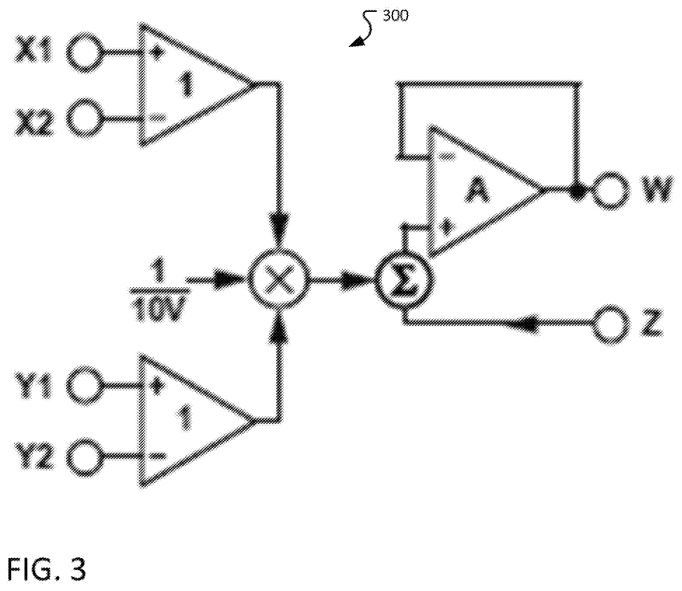

In this example, the aggregation function for each hidden-layer neuron consists of 35 interconnected ANALOG DEVICES AD633AN four-quadrant analog multiplier chips. FIG. 3 is a functional block diagram 300 for the AD633AN four-quadrant analog multiplier chip. The chip's transfer function is

$$W = \frac{( X 1 - X 2 ) \cdot ( Y 1 - Y 2 )}{10 V} + Z .$$

In the block diagram 300 of the AD633AN chip, the X2 and Y2 inputs are set to 0 V, the X1 inputs are driven by input pixel voltages and the Y1 inputs are driven by synapse weight voltages (uniformly distributed between ±10 V). The multipliers are daisy chained by connecting successive outputs W to inputs Z to result in the aggregate.

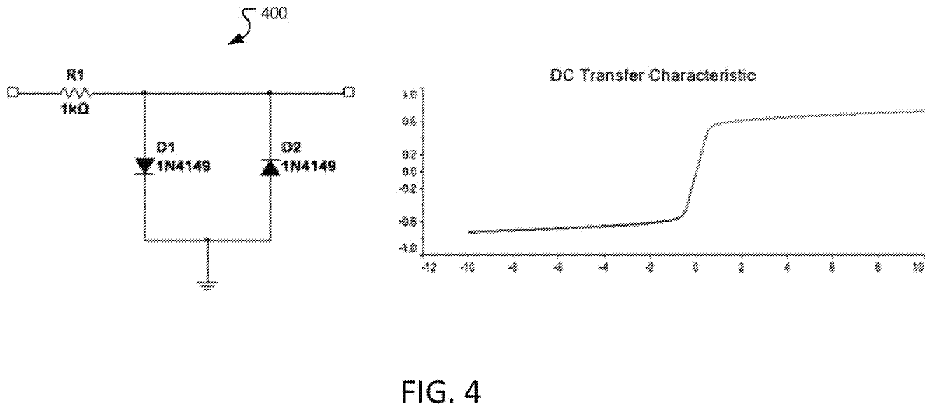

FIG. 4 is a diagram of an activation function circuit 400 and its voltage transfer characteristic curve for the AD633 chip used in the example described above. The activation function circuit 400 includes PN-diode clipping circuits with diodes D1 and D2, which provide the hidden-layer activation functions.

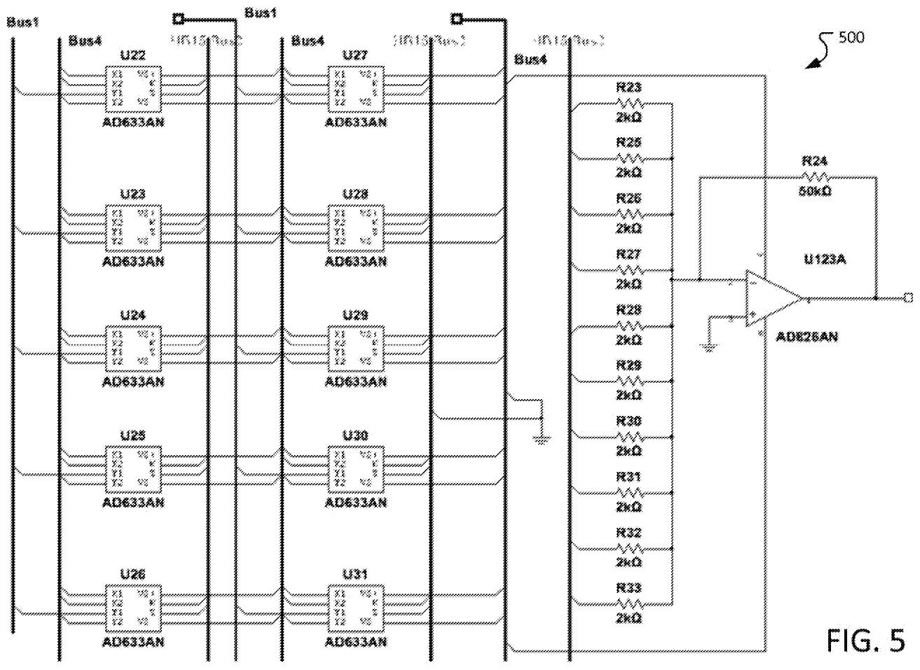

AD633AN multiplier chips can also realize the aggregation function for each output-layer neuron. However, because training circuits have to find the 100 output-layer synapse weight values, these multipliers are not daisy chained, which avoids daisy chain ripple delay during training. Here inputs Z are set to 0 V and outputs W connect to op-amp adders to execute the sums in parallel rather than in sequence via daisy chains. FIG. 5 is a diagram of an output-layer neuron aggregation circuit 500 using an AD826ANError! Bookmark not defined. inverting op-amp adder, showing three of the ten multiplier blocks.

Error! Reference source not found. is a diagram of a training circuit 600 for a single output-layer neuron. The training circuit 600 includes the electronics of Error! Reference source not found. as abstract multiplier and adder symbols. For the perceptron 100, there are ten such training circuits 600 in total, one for each output-layer neuron, for example, one for each of the numerals 0-9. Signals “Weight1”, “Weight2”, . . . “Weight10” are common to all ten output-layer neurons, whereas each output-layer neuron receives a unique set of “Activation” signals from the hidden (inner) layer, namely the signals generated by that neuron's corresponding input numeral. For example, neuron eight gets “Activation” signals generated by input numeral “8”, etc.

The output-layer signal “Aggr” 602 drives “Op amp1” 604 to generate the signal “Weight1” 606 which is captured by the track-and-hold circuit 608. The track-and-hold circuit feeds “Weight1” 606 back to the output-layer neuron to form the product “Weight1”×“Activation1” 618. The polarity of the feedback loop therefore depends on the sign of the hidden-layer neuron signal “Activation1”; so analog comparator “Comp1” sets the input connections of “Op amp1” 604 through switch “S1” to guarantee a negative feedback configuration. Although the sign of the hidden-layer signal “Activation1” can be either “+” or “−”, once its value is randomly determined it remains fixed, i.e. it does not change during training.

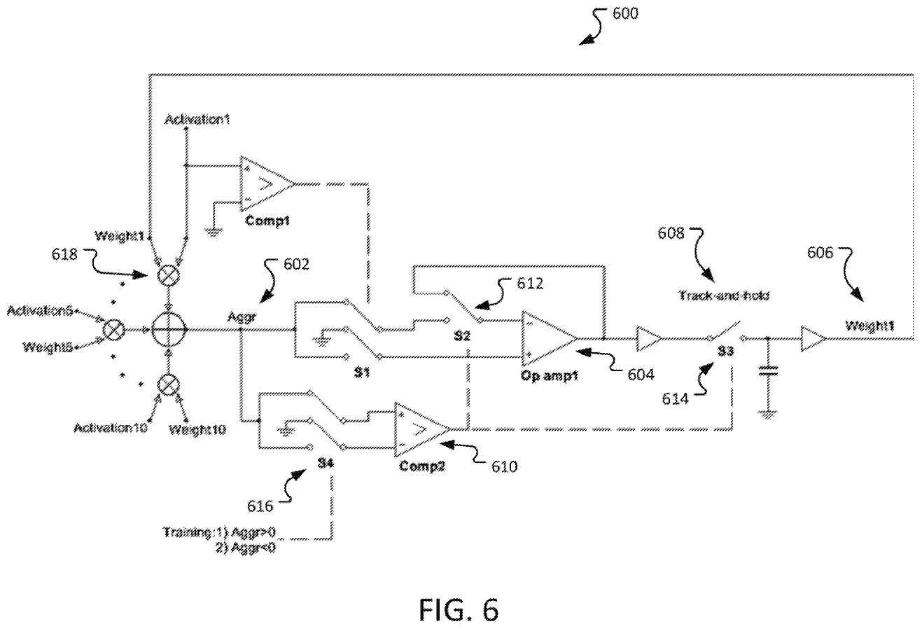

The output-layer signal “Aggr” 602 also drives analog comparator “Comp2” 610 which controls switches “S2” 612 and “S3” 614 to set the training circuit to either its “track” or “hold” mode. FIG. 6 shows switches “S2” and “S3” in their “hold” state. Switch “S2” 612 moreover keeps “Op amp1” 604 from going open loop while in “hold” mode.

The user sets switch “S4” 616 to achieve the desired training outcome: either “pattern recognized” or “pattern ignored.” With switch “S4” 616 in its “up” state, as shown in Error! Reference source not found., analog comparator “Comp2” 610 puts switches “S2” 612 and “S3” 614 in track mode for output-layer signal “Aggr”>0. For output-layer signal “Aggr”<0, analog comparator “Comp2” 610 puts switches “S2” 612 and “S3” 614 in hold mode and the feedback loop opens, locking down “Weight1” 606. This corresponds to “pattern ignored”. “Weight1” 606 stays fixed as long as output-layer signal “Aggr”<0, but will readjust if output-layer signal “Aggr” wanders above zero (“Aggr”>0) during training.

With switch “S4” 616 in its “down” state, analog comparator “Comp2” 610 puts switches “S2” 612 and “S3” 614 in track mode for output-layer signal “Aggr”<0. For output-layer signal “Aggr”>0, analog comparator “Comp2” 610 puts switches “S2” 612 and “S3” 614 in hold mode and the feedback loop opens, thereby locking down “Weight1” 606. This corresponds to “pattern recognized”. “Weight1” 606 stays fixed as long as output-layer signal “Aggr”>0, but will readjust if output-layer signal “Aggr” wanders below zero (“Aggr”<0) during training.

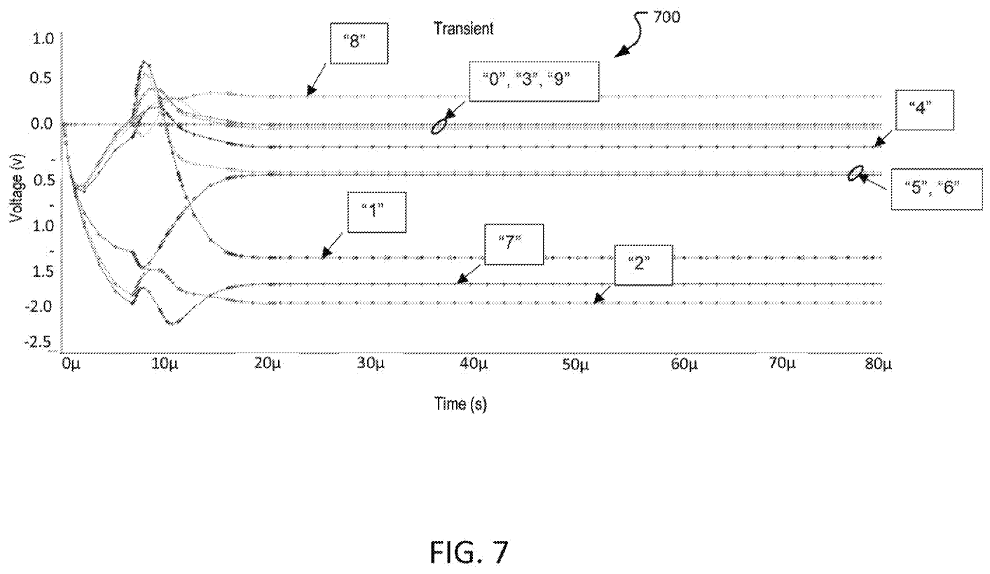

The ten training circuits 600 in the perceptron 100 provide ten equations in the ten unknown weights. Each training circuit 600 has feedback control of one specific weight value. All ten output neurons receive the same ten weights. Each output neuron receives its own unique set of “Activation” signals corresponding to the specific input numeral that the neuron is to “recognize” or “ignore.” For example, to recognize an “8”, the user would put output neuron 8 in “recognize” mode while putting the remaining nine neurons in “ignore” mode. Training ends when all output-layer synapse weights lock, giving the specific settings for the neuron's ten weights that result in output-layer signal “Aggr”>0 for input “8” and output-layer signal “Aggr”<0 for the other nine input numerals. FIG. 7 illustrates this specific case, showing a graph 700 of output voltage transients for ten aggregation function circuits configured to recognize digit “8” and ignore digits “0”-“7” and “9.”

The graph 700 shows ten “Aggr” output-layer signal voltage transients. During the first 6 μs all ten outputs have output-layer signal “Aggr”<0, thus nine of the ten output neurons have their training circuits in hold mode while output neuron 8's training circuit is in track mode. Accordingly, during the first 6 μs, only one of the ten weights is adjusted by feedback and the other nine weights are locked down. However all ten output neurons receive the same ten weights, so all ten “Aggr” outputs change in response to the single adjusted weight. Some of the “Aggr” outputs swing up and others down because each output neuron has its own unique set of “Activation” signals from the hidden layer, some with positive values and others with negative values.

By the 6.5 μs mark, feedback has driven the “Aggr” output of neuron 8 above the 0 V threshold, thereby switching its training circuit to hold mode. Meanwhile five other “Aggr” outputs have also risen above the 0 V threshold, putting their training circuits in track mode thus enabling feedback which forces them back below 0 V. After about 20 μs, all ten training circuits are in hold mode and all weights are locked, signifying recognition of the numeral “8”. Similar results can be obtained for recognition of digits 0-7 and 9.

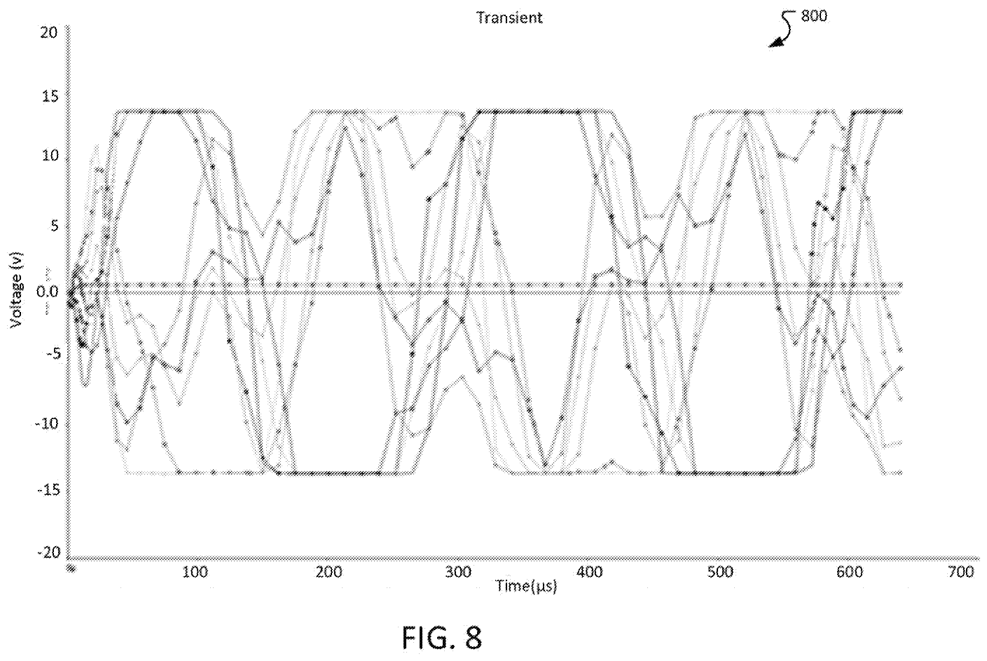

Each output-layer neuron produces an “Aggr” output-layer signal that drives an op amp to generate one of the ten weight signals. There are 10!=3,628,800 different possible ways to configure the feedback weight assignments. The weight values may fail to lock down if arbitrary weight assignments are made in disregard of certain “selection rules.” This is due to the contention that can occur whenever two or more training circuits are simultaneously put into track mode. The training circuits can vie for control, unless their weight assignments are made according to the selection rules. The selection rules take into account both the signs and magnitudes of the “Activation” signals. FIG. 8 is a graph 800 illustrating a failure of output voltage transients to converge. The graph 800 shows an example of how the ten “Aggr” signals can oscillate if the weight assignments violate the selection rules.

The application of analog electronic feedback loops provides real-time adjustment of ANN “synapse” weights. This enables the perceptron system to train all weights in parallel, at the response speed of the analog electronics (i.e. nanoseconds) regardless of the number of neurons.

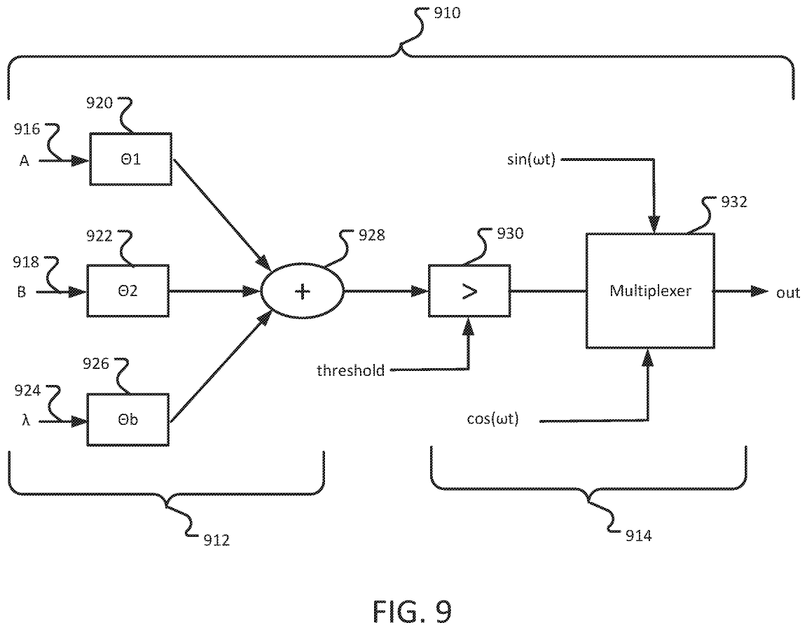

One type of neuron suitable for use in self-trained analog ANN circuits includes a complex-valued neuron. FIG. 9 shows a block diagram of a complex-valued artificial neuron 910. The complex-value neuron 910 includes an aggregator portion 912 for receiving and combining input signals and an activating portion 914 for determining a logical output on the basis of the input signals. The input and output signals are continuous valued signals, such as sines or cosines. Continuous signals may also include other periodic signals having a phase and frequency, and/or signals having a defined signal level for a finite time interval.

The logic state of either an input or an output signal may be encoded in the phase of the signal. For example, in a two-state logical system, a logical “zero” can be represented by a cosine wave, and a logical “one” can be represented by applying a ninety degree phase shift, thereby forming a sine wave. Multi-state value systems can be implemented by encoding the additional value states as different phase angles.

In the artificial neuro 910 of FIG. 9, the aggregator portion 912 includes first and second analog inputs 916 and 918 in communication with respective first and second phase delays 920 and 922 respectively. A third analog input 924 receives a bias signal, which is provided to a bias delay 926. These delays 920, 922, 926 apply phase shifts to their respective input signals. The phase-shifted input signals and the phase shifted bias signal are then added together at a summer 928.

The activating portion 914 includes a comparator 930 configured to control a selection made by a multiplexer 932. The comparator 930 compares the output of the summer 28 with a threshold value. The output of the comparator 930, which may be a DC voltage level, is fed to a selector input of the multiplexer 932 to control which of two, or more, candidate signals supplied to the multiplexer 932 will be passed to an output thereof.

In the illustrated implementation, the candidate signals are sinusoids in phase quadrature, sin(ωt) and cos(ωt), each one of which corresponds to a logic state. However, any signal having a well-defined phase can be used. For example, the candidate signals can also be square waves or pulse trains in phase quadrature.

The illustrated neuron 910 can be programmed to implement any one of the Boolean logic gates by suitably selecting values for the phase shifts corresponding to the three delays 920, 922, 926. For example, to implement an AND gate, one would set the first and second phase shifts, for 920 and 922 respectively, to 180 degrees. The bias phase shift 926 would be zero degrees, and the amplitude of the bias signal 924 would be unity. As another example, for an XOR gate, the amplitude of the bias element is zero and the first and second phase shifts, for 920 and 922, are 0 degrees and 180 degrees respectively. Therefore, the summation of the input signals by summer 928 amounts to a subtraction. As a result, no explicit phase-shifting circuitry is required.

### Other Implementations

It is to be understood that while the invention has been described in conjunction with the detailed description thereof, the foregoing description is intended to illustrate and not limit the scope of the invention, which is defined by the scope of the appended claims. Other aspects, advantages, and modifications are within the scope of the following claims.

What is claimed is:

1. A system comprising:
an integrated circuit comprising:
artificial neural network circuitry, and
training circuitry configured to train the artificial neural network.

2. The system of claim 1, wherein the artificial neural network circuitry employs a plurality of artificial neurons, wherein at least one artificial neuron of the plurality of artificial neurons adjusts an input signal using a weight; and
wherein the training circuitry is configured to train the artificial neural network by adjusting the weight of the at least one artificial neuron.

3. The system of claim 2, wherein each of the plurality of artificial neurons is
configured to be trained in parallel.

4. The system of claim 2, wherein the training circuitry is configured to train each of the plurality of artificial neurons in parallel.

5. The system of claim 1, wherein the training circuitry includes a track and hold circuit that provides a value based on a weight to the artificial neural network circuitry, wherein the weight is generated based on an output-layer of the artificial neural network circuitry.

6. The system of claim 5, wherein the value is further based on a signal from a hidden layer of the artificial neural network.

7. A method for training an artificial neural network, the method comprising:
providing input signals and at least one output signal to an integrated circuit, wherein the integrated circuit comprises artificial neural network circuitry and training circuitry configured to train the artificial neural network; and
training the artificial neural network using the training circuitry, wherein the training comprises adjusting weights in parallel based on the at least one output signal, wherein the weights are applied to the input signals by artificial neurons employed by the artificial neural network circuitry.

8. The method of claim 7, wherein the training circuitry includes a track and hold circuit that provides a value based on a weight to the artificial neural network circuitry, wherein the weight is generated based on an output-layer of the artificial neural network circuitry.

9. The method of claim 8, wherein the value is further based on a signal from a hidden layer of the artificial neural network.

10. The method of claim 7, wherein artificial neurons in the artificial neural network is trained in parallel.

11. A system for using a trained artificial neural network, the system performing operations comprising:
providing input signals to an integrated circuit comprising:
trained artificial neural network circuitry,
training circuitry configured to train the artificial neural network, and
output circuitry configured to provide an output from the artificial neural network circuitry,
wherein the trained artificial neural network circuitry has been trained by the training circuitry; and
receiving an output from the output circuitry.

12. The system of claim 11, wherein the artificial neural network circuitry employs a plurality of artificial neurons, at least one artificial neuron adjusting an input signal using a weight; and
wherein the training circuitry is configured to train the artificial neural network by adjusting the weight of the at least one artificial neuron.

13. The system of claim 11, wherein the training circuitry includes a track and hold circuit that provides a value based on a weight to the artificial neural network circuitry, wherein the weight is generated based on an output-layer of the artificial neural network circuitry.

14. The system of claim 13, wherein the value is further based on a signal from a hidden layer of the artificial neural network.

15. The system of claim 11, wherein each artificial neuron in the artificial neural network is configured to be trained in parallel.
